(19) United States
(12) Patent Application Publication
(10) Pub. No.: US 2019/0026492 A1
(43) Pub. Date: Jan. 24, 2019

(54) PROTECTED PII OF MOBILE DEVICE DETECTION AND TRACKING

(71) Applicant: BlueFox, Inc., Saratoga, CA (US)

(72) Inventors: Thomas Sandholm, Saratoga, CA (US); Hang Ung, Saratoga, CA (US); Philippe René Morin, Goleta, CA (US)

(21) Appl. No.: 15/803,689

(22) Filed: Nov. 3, 2017

Related U.S. Application Data
(63) Continuation-in-part of application No. 15/792,699, filed on Oct. 24, 2017.
(60) Provisional application No. 62/535,830, filed on Jul. 22, 2017.

(51) Int. Cl. G06F 21/62; H04L 9/06; H04W 4/02; H04L 9/00

(52) U.S. Cl. CPC G06F 21/6254; H04L 9/0643; G06F 17/30324; H04L 9/002; H04W 4/02

(57) ABSTRACT

Disclosed herein is a technique to mask personally identifying information (PII) in a people counting system. A sensor that capable of identifying individual mobile devices, such as smart phones, counts people in a given area. Once identified, information that identifies given mobile devices is hashed. The hashed data is used with a filter to determine recurrence of individuals without actually storing any information specifically about those individuals. In order to determine the count of people externally from the sensor, the hashed data is analyzed for cardinality.

### CROSS-REFERENCE TO RELATED APPLICATIONS

The presently filed application is a continuation-in-part application of U.S. patent application Ser. No. 15/792,699 entitled “SCALABILITY IMPROVEMENTS OF PEOPLE-COUNTING SENSOR NETWORKS”, filed Oct. 24, 2017, and claims priority to U.S. Provisional Application No. 62/535,830 entitled “MOBILE DEVICE DETECTION AND TRACKING”, filed Jul. 22, 2017, each of which are incorporated by reference herein in their entirety.

### TECHNICAL FIELD

Teachings relate to electronic data management and more specifically, but not exclusively, to protecting personally identifiable data of respective mobile devices of tracked people.

### BACKGROUND

People tracking via mobile devices often involves a system that scrapes MAC addresses or other types of machine identifiers from the mobile devices. Machine identifiers are often long strings of characters that when tied to additional data may provide inferences about a given person's private life. Personally identifiable information (PII), or sensitive personal information (SPI), as used in information security and privacy laws, is information that can be used on its own or with other information to identify, contact, or locate a single person, or to identify an individual in context.

### BRIEF DESCRIPTION OF THE DRAWINGS

FIG. 1 is an exemplary top-level block diagram illustrating an embodiment of a mobile detection system.

FIG. 2 is a flowchart illustrating a method of logging a mobile device.

FIG. 3 is an illustration of a bitmap for storing mobile device identifiers.

FIG. 4 is a flowchart illustrating a method of rolling bitmaps for consistent coverage.

FIG. 5 is a Flowchart illustrating data management between a detector and an application server.

FIG. 6 is a flowchart illustrating a method of maintaining multiple bitmap tracking systems over variable time periods.

FIG. 7 is a block diagram illustrating a scaled network architecture.

FIG. 8 is a flowchart depicting ingestion and processing of raw data.

FIG. 9 is a flowchart depicting report generation involving summarized data modified by approximated statistics.

FIG. 10 is a block schematic diagram of a system in the exemplary form of a computer system within which a set of instructions for causing the system to perform any one of the foregoing methodologies and logical flows may be executed.

### DETAILED DESCRIPTION

Disclosed herein is a technique to improve the processing of people counting devices. In order to achieve these goals, the technique involves the use of a device that counts the local number of wireless/mobile devices. When the counting device scrapes a machine identifier from a mobile device, the identifier is hashed using a one-way hash function. The hash code corresponds to a bit location on a bitmap. The location in the bitmap is checked. If the bit is already marked full, the mobile device has been previously detected, if the pixel location is empty, this is a new device. Thus, a single bit represents each machine identifier.

The bitmap system is computationally light and enables the person counting device to operating more efficiently.

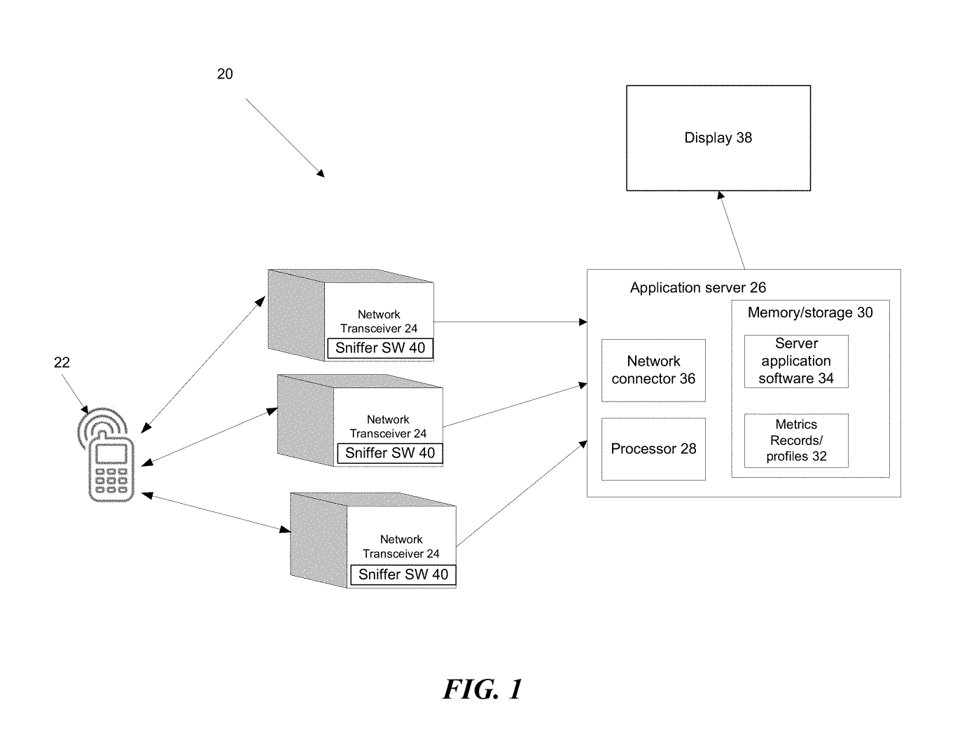

FIG. 1 is a block diagram illustrating an embodiment of mobile detection system 20. The system 20 relates to mobile devices 22 carried on a user's person. The mobile devices 22 are detected by network transceivers 24. Network transceivers 24 are detection devices or mobile stations (MS), which colloquially can be referred to as fake hotspots or sniffers, that collect identification data from mobile devices 22. Data collected by the network transceivers 24 is forwarded to an application server 26 via the Internet. The application server 26 includes a processor 28 and a data storage or memory 30 for logging metrics 32 and running application analytical software 34. The results of the analysis of metrics 32 are displayed or rendered to a user on a display 38.

Mobile devices such as cellular phones, tablets, or other portable networked devices emit signals in Bluetooth, WiFi, and cellular (i.e. 2G, 3G, 4G, Edge, H+, etc.). These signals attempt to connect to paired devices, hotspots, cell towers, or other suitable wireless connection points to greater networks (“hotspots”). In order to connect to hotspots, mobile devices send out identifying data to establish a connection.

If the mobile device is tricked into attempting to connect with a network transceiver disguised as a hotspot, the fake hotspot may unobtrusively collect the identification data of the mobile device (such as a machine identifier) and then reject the connection request. The fake hotspot collects data in real-time on the mobile device, and by association, collects data regarding the human carrying the mobile device. This data collection occurs without alerting or impeding the human carrier. The system uses analytical software to determine, for example, an approaching unique ID user's presence, history, frequency of visits, duration of presence, and so on. The type of data available to the fake hotspots varies based on a number of details, such as the kind of hotspot used.

In some embodiments, a dashboard selects and controls data that is received from the network transceivers 24 at the application server 26. The dashboard can control, from a distance, data captured by the network transceivers 24 as well as new visitor characteristics, history of data used, the number of mobile devices that can be sensed, demographics regarding a selected user, and so on.

The network transceivers 24 may include a plurality of sensors and communicative devices. Examples include wireless fidelity (WiFi) sensors, cell signal 2G, and Femto sensors for 3G and 4G for sensing a user's mobile device 22.

Mobile devices 22 emit WiFi signals automatically. WiFi signals carry identifying data including the MAC address (unique ID number), power of the signal, distance of mobile device 22 from the network transceiver 24, brand of the mobile device 22, name of the mobile device 22 (given by the user), and the network name the mobile device 22 used to connect.

Cell signals (2G, 3G, 4G, etc.) emitted by a phone also occur automatically. The network transceivers 24 detect this signal with an active action on a regular basis to collect the MAC address (unique ID number), SIM card number (IMSI), power of the signal, distance of mobile device 22 from network transceiver 24, carrier, nationality of the mobile device 22, list of applications which attempt to update, and the addresses of the web pages already open (or cached) on the mobile device 22.

Cell signal in this case refers to both CDMA and GSM type networks. While normally CDMA networks would not necessarily use mobile devices 22 with SIM cards, SIM cards exist in devices that use 4G LTE signals. Additionally, in the U.S., CDMA carriers use network-based whitelists to verify their subscribers. The mobile device 22 will still have a unique ID for the carrier to use for identification.

The network transceivers may additionally include processors 28 for internal operations and/or for accepting some of the analytical processing load from the application server 26. Network transceivers 24 may also employ sniffer software 40. Sniffer software 40 includes program operations of the network transceivers 24 as well as network protocol software. Examples of network protocol software include adaptations of OpenBTS (Open Base Transceiver System) and OpenBSC (Open Base Station Controller), with additional features as taught herein. OpenBTS is stable, more complete for GSM, and has a release for UMTS

(Universal Mobile Telecommunications System). OpenBTS includes the functionality to perform complete man-in-the-middle attacks. It is worth noting that OpenBSC makes use of OpenBTS for its BTS functionalities.

Using OpenBTS software, examples of base model hardware that may be used for the network transceiver are adaptations of communications platforms manufactured by Ettus Research, Fairwaves, and Nuand.

For cellular signals, there are two distinguishable cases: idle mode and non-idle mode. In idle mode, the mobile device 22 performs the selection and re-selection of a base station to make sure that the mobile device 22 is attached with the best possible channel to the carrier network. In non-idle mode, a mobile device 22, with a point-to-point active call, will perform a base station handover to assure that the call is not dropped.

In order for the mobile device 22 to choose to identify itself to the network transceivers 24, the mobile device 22 has to reselect the cell managed by the network transceivers 24 and push them to identify/authenticate. A set of criteria is defined in the standard mobile phone regarding this selection/re-selection procedure. A BCCH frequency scan can be described as follows: the mobile device 22 scans a set of frequencies to detect a BCCH frequency to camp on. Criteria for cell eligibility can be selected or re-selected. These cells include timing information. In some embodiments, every five seconds, the network transceiver 24 calculates the parameters for the serving cell and for non-serving cells.

GSM, UTRAN, and/or LTE (2G, 3G, 4G) cell reselection is feasible. Therefore, within the sniffer software 40 are programmed, unique approaches for each. According to the network requests, a network transceiver 24 provides specific identification parameters to a fake network (e.g., IMSI or IMEI). The network initiates the identification procedure by transferring an IDENTITY REQUEST message to the network transceiver 24 and starts a timer T3270. The IDENTITY REQUEST message specifies the requested identification parameters in the identity type information element. The IMSI and/or IMEI may be requested.

In some embodiments, the data network includes a wired data network and/or any category of conventional wireless communication networks; for example, radio, Wireless Fidelity (WiFi), cellular, satellite, and broadcasting networks. Exemplary suitable wireless communication technologies include, but are not limited to, Global System for Mobile Communications (GSM), General Packet Radio Service (GPRS), Code Division Multiple Access (CDMA), Wideband CDMA (W-CDMA), CDMA2000, IMT Single Carrier, Enhanced Data Rates for GSM Evolution (EDGE), Long-Term Evolution (LTE), LTE Advanced, Time-Division LTE (TD-LTE), High Performance Radio Local Area Network (HiperLAN), High Performance Radio Wide Area Network (HiperWAN), High Performance Radio Metropolitan Area Network (HiperMAN), Local Multipoint Distribution Service (LMDS), Worldwide Interoperability for Microwave Access (WiMAX), ZigBee, Bluetooth, Flash Orthogonal Frequency-Division Multiplexing (Flash-OFDM), High Capacity Spatial Division Multiple Access (HC-SDMA), iBurst, Universal Mobile Telecommunications System (UMTS), UMTS Time-Division Duplexing (UMTS-TDD), Evolved High Speed Packet Access (HSPA+), Time Division Synchronous Code Division Multiple Access (TD-SCDMA), Evolution-Data Optimized (EV-DO), Digital Enhanced Cordless Telecommunications (DECT), and others.

The sensors can acquire data on the media access control (MAC address), signal strength, timestamp of probes received, and so on, from the mobile device. In some embodiments, the sensors can be integrated into the display device and/or placed as a separate unit collecting data metrics per location and uploading them to the central server. Additional sensors improve the accuracy of the wireless metrics as well as cover multiple areas within a location. Other sensors that can be used include Bluetooth, GSM/2G, and so on.

The raw data available from the network transceiver 24 is rather diverse. A non-exhaustive list of data available includes: a timestamp of detection, point of origin of detection, region of origin of detection, dwell time in the region or point, a detected location of person, a device ID for the detected device, and an exiting timestamp. The character of each of this data may also vary based on sensor. For example, the location of a detected person may be a specific point. This may be calculated from triangulation of three sensors. Alternatively, the person's location may be a distance from a given sensor. This is calculated by signal strength between the network transceiver 24 and the mobile device 22. Additional knowledge of how the network transceiver is positioned can provide additional context to the location.

The device ID may be specific or generalized. An example of a specific device ID is a MAC address, whereas a generalized device ID may be a designation the network transceiver 24, or application server 26 applies to the device. A generalized device ID may have a smaller data size than a MAC address, and thus be an effective tool in scalability of the system. Keeping track of specific points (sensors) and regions (groups of sensors) is also relevant in terms of tracking a given individual within a given region (group of sensors). If a person moves from one sensor to another this may not be interpreted as a new person, but rather a continued stay (dwell time) of the same person. Keep tracking of this at a low level in the network (initial intake server or at the sensor level) reduces the overall data intake of the system and improves the scalability.

The origination point or region may be defined as an original detecting sensor or a group of sensors respectively. The relevance of each depends on the network needs, and placement. Where specificity is important, the particular sensor, or point or origin may be important. In other implementations, a broader answer may be acceptable.

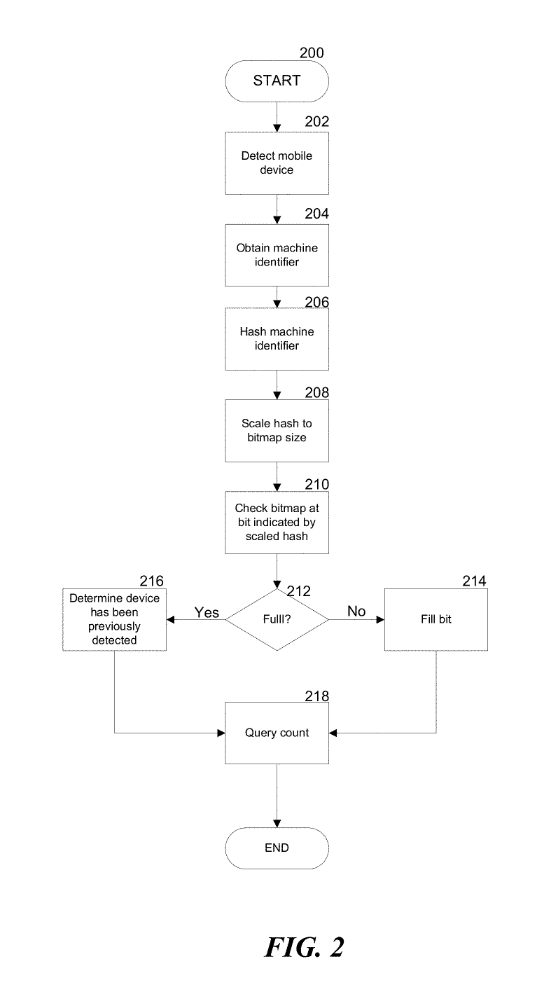

FIG. 2 is a flowchart illustrating a method of logging a mobile device. Ultimately, the goal is to store the data of a MAC address (˜6-8 bytes) with significantly less data, such as a single bit of data. In step 202, a mobile device detection system detects a first mobile device. In step 204, the detection system obtains the first mobile devices machine identifier. The machine identifier may be a MAC address, a SIM card identifier, or another suitable form of device identification known in the art.

In step 206, the machine identifier is processed through a one-way hash function. The hash function is consistent such that for the same input, the hash function will always produce the same output. Further, the hash function produces output across a wide range. As with any hash function, the goal is to reduce the total number of possibilities of input to a smaller list of possible outputs. The input, a MAC address for example, has a high degree of complexity (˜6-8 bytes). The output is less than that. The hash function thus accepts a degree of possible error (duplicates) in favor of speed/less memory usage.

In some embodiments the hash function treats different portions of a MAC address differently. For example, for MAC addresses with multiple parts, a vendor MAC and a device-specific MAC, the hash function may process the MAC in separate parts. In some cases, for popular mobile devices, the vendor MAC may be identical for many devices. Thus, in these embodiments, some vendor MACs are assigned a greater share of the range of output of the hash function. It's expected that the detection system will encounter many devices from the given vendor as opposed to another vendor. The less popular vendors are less likely to have collisions in data, so these vendors are given a smaller share of the potential output of the hash function. In some embodiments, the hash function may also “salt” the MAC addresses before hashing to increase variance.

In some embodiments, the hash function resolves the issue of having a popular vendor by generating highly varied output despite having similar input. This can be achieved by rearranging the characters of the MAC address (both portions vendor and device portions together), or using select characters from both the vendor MAC and the device MAC portions to create more varied combinations. Thus, even though the vendor MACs across many devices are very similar (or the same), the respective MACs would still have very different hashes.

In step 208, the hash of the mobile device machine identifier is scaled to the bitmap used. The bitmap(s) used by a given detection system are sized based on the length of time a given bitmap is expected to operate and what expected traffic by the detection system is. A system expecting 100 people during a given period would have use a notably smaller bitmap than a detection system expecting 50,000 people in the same period. In some embodiments, expecting 100 devices can be supported by a bitmap including two to the 10-12th power of bits (˜1 k-4 k of data). Thus, the scaling function scales the output of the hash function to a corresponding location in the used bitmap depending on the size of the bitmap.

In step 210, the detection system checks the bitmap at the bit indicated by the scaled hash output. In step 212, the detection system determines whether that bit is full (0 or 1). If the bit is empty, in step 214, the detection system fills the bit, and the device is considered detected. If the bit is full, in step 216, the detection system has seen that device before (since the previous clear of the bitmap) and this device has already been counted.

In step 218, the detection system queries the count of devices. The query checks the relevant bitmap(s) and counts the number of full bits. The number of full bits is the number of devices in range of the detection system. Some device may fill the same bit, and thus there is a potential degree of error; however, this error is acceptable when generating estimates people counting.

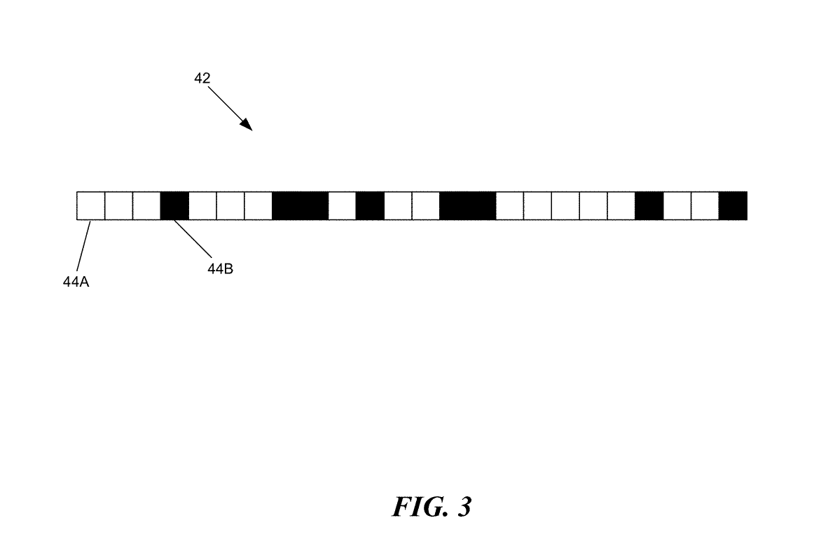

FIG. 3 is an illustration of a bitmap 42 for storing mobile device identifiers. The bitmap is a binary data structure. In some embodiments, a single row bitmap 42 is used to store detection of particular devices. Devices are identified by a location designated by a one-way hash function (and in some embodiments, a scaling function) in the bitmap 42. In other embodiments, different configurations of bitmaps 42 (such as having multiple rows and columns) are usable as long as each has distinct locations, or bits. The figure includes both empty bits 44A and full bits 44B.

An empty bit 44A indicates that the corresponding device has not been detected since the last time the bitmap 42 was cleared. A full bit 44B indicates the corresponding device was detected since the previous bitmap clear. The size of the bitmap 42 varies based on the length of time the bitmap 42 is intended to operate for. As the intended operation time grows, so must the size of the bitmap 42. The bitmap 42 may be referenced for queries concerning particular bits, the number of full bits at any given time, and copy and clear functions. The bitmap 42 of FIG. 3 displays eight detected devices as represented by eight full bits 44B.

In some embodiments the scaling of hashed data to the bitmap corresponds the hashed identifier to multiple bits within the bitmap. Thus, for the hashed data to return as having been detected, the bitmap must have all of the bits associated with that hashed data full.

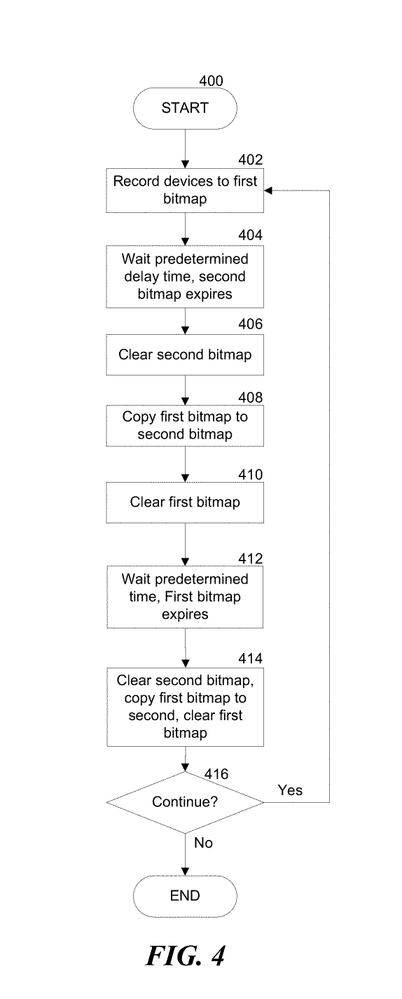

FIG. 4 is a flowchart illustrating a method of rolling bitmaps for consistent coverage. If a given bitmap runs for long enough, every bit will be full, or the number of collisions will no longer be within an acceptable margin of error. Thus, the bitmap needs to be cleared every so often. However, clearing all data ruins the count as the bitmap is cleared. In order to resolve this issue, two or more bitmaps are used in a rolling fashion in order to determine the count.

In step 402, a first bitmap is operated and filled as described in FIG. 2. Devices are detected, their machine identifiers are hashed and scaled to a bitmap, and then bits are filled as devices are detected. The bitmap may be queried for the count.

In step 404, the detection system waits a predetermined delay time from the initializing of the first bitmap in order to begin a second bitmap. The second bitmap matches the first bitmap in size, thus any bits full on the first bitmap correspond to the same device on the second bitmap (within the margin of error). In step 406, the second bitmap is cleared of bits (if any). In step 408, the full bits of the first bitmap are copied to the second bitmap (via union function). In step 410, the first bitmap is cleared. While the first bitmap is cleared, detected devices are continuously recorded to the first bitmap.

In step 412, the detection system waits a predetermined delay time until the first bitmap expires. In step 414, the second bitmap is cleared again, the first bitmap is copied into the second bitmap, and then the first bitmap is cleared (repeat steps 406-410). When a device is detected, the corresponding bit is filled (or recognized as full) in the first bitmap.

If the detection system continues to operate, then the method restarts from step 402. In this manner, two bitmaps run simultaneously, though are staggered. In this manner, the count is never drops to zero suddenly (unless the count is actually zero) as one bitmap is cleared. The current data is queried from both of the bitmaps and added together.

In some embodiments, this method operates with additional bitmaps. Additional bitmaps (beyond two) enables the detection system to provide counts over a greater granularity of time. For three bitmaps, each might have a lifetime of 3.33 minutes. Thus, a given device would remain in the system for a minimum of 6.67 mins and maximum 10 min. The average time of accounting for a phone is 8.34 minutes (6.67+3.33/2). Therefore, the discrepancy is 1.67 minutes.

In this manner, the detection system can guarantee that a given user's information (or a hashed and scaled version of the information) is stored greater than the total lifespan of two bitmaps. Where there are only two bitmaps, the given user's information is stored for a maximum of one lifetime plus the interval between the two bitmaps. For example, if two bitmaps operate with a lifespan of 5 minutes, then the average length of time a user's information may be stored without their continued presence is 7.5 minutes. For three bitmaps the system is able to tell if a phone was seen within 0-3.3 min, 3.3-6.6 min or 6.7-10 min as opposed to just 0-5 and 5-10 min.

Other combinations of shared writes and clears of the rolling bitmaps are also suitable. For example, a clear of both bitmaps is not necessary after the expiration of each of the bitmaps. For example, the method functions if only the first bitmap is cleared when the first bitmap expires, and only the second bitmap is cleared when the second bitmap expires (e.g., skip step 410, and the first portion of step 414 that is corresponds to step 406).

In some alternate embodiments, the process may additionally work where the two bitmaps alternate as the bitmap recording detected devices. The first bitmap records devices for half of its respective lifespan. Halfway through the lifespan of the first bitmap, the second bitmap becomes the recording bitmap. Counting is performed by comparing the full bits of both bitmaps. When any given bitmap expires, it is zeroed out and then takes over as the recording bitmap.

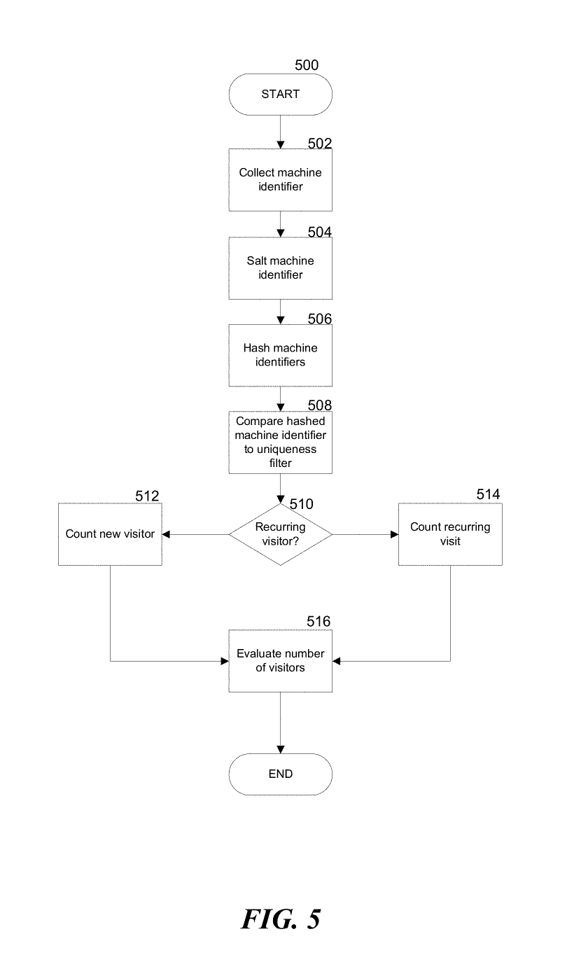

FIG. 5 is a flowchart illustrating data management between a detector and an application server. Many people do not like having their personal identifying information (PII) stored with or without their knowledge. Thus, it is useful to build a system where a given device's machine identifier is never actually stored or recorded for any period. A potential issue is that where a machine identifier is stored and tracked at multiple locations, a map for that specific person (who carries the specific machine with them everywhere) begins being constructed.

For example, a given circumstance includes a plurality of people sensors placed around a city and a given person that moves about and is sensed, via their mobile device, at a number of these sensors. The police then arrest the given person for being suspected of a crime. Naturally, wanting to build their case, the police check the given person's mobile device for its machine identifier and then try to subpoena records of the people sensors in order to place the suspect at the crime scene in a designated time window.

This sounds great for the police, but triggers a privacy interest in the suspect. Private citizens have an interest in not being traced as they live their lives. Further, the reliability of the information, for purposes of prosecuting criminals beyond a shadow of a doubt, is suspect at best. Machine identifiers can be faked. The people sensors can be tricked. Additionally, handling a stream of information requests from the police can be very expensive from a business standpoint.

A solution is to not have the requested information. One way to ensure ignorance is to merely never record the machine identifier or any identifying information about the device at all. The fact that a visit record exists at a given time alone is enough to obtain the data for census purposes. It is not necessary that the visit record be associated with a given identifier. If a visit need be assigned a visitor identifier, the identifier may be completely random (e.g., no relation to the original identifier, nor obtained via any function performed with the original identifier).

Another way to ensure ignorance is to hash the machine identifiers when obtained, and then use the hashed value to determine uniqueness and cardinality. Because the hash function is one-way, and includes some collisions the police (or another interested party) would not be able to reliably determine if a given machine identifier had visited a particular people sensor (e.g., there are multiple machine identifiers that would hash to the same value, also known as collisions). In some embodiments the hash function includes a salt value that greatly changes the hash value for a given machine identifier. In some embodiments, the salt value is contextualized to blur the ability to trace recurrence of visitors.

For example, in some embodiments, there is localized tracking of visit recurrence. In order to implement that a salt value based on the sensor that detected a given phone may be used as salt. In this way, if that sensor continues to detect that phone, the hash value will continue to appear the same; however, if that same device is detected by another sensor, the hash value will be different and the device will be treated as a new, unique visitor because the salt value will cause an unpredictably different hash value.

Another example is to periodically change the salt value based on blocks of time (e.g. hourly, daily, weekly). Thus visit recurrence may only be tracked within that block of time. In the next block of time, the same device would hash to a completely different hash value based on the new salt value. Salt values may also be based on a cryptographic key, or a constant.

Further, a combination of any of the above contexts may be used to further narrow the ability to track visit recurrence (e.g. both time and sensor based so visit recurrence is only traceable from that sensor in that time block).

A device's machine identifier is never recorded or transmitted. When detected by an on-site detector device (“detector”), the detector immediately hashes the machine identifier. In various embodiments, the bitmaps 40 are ultimately stored on the detectors in a local memory 30A, or on the application server 26 in the server memory 30B. As a result that the bitmaps require such little storage space, they may be stored in the fastest forms of cache memory (thereby increasing the processing time). In some embodiments, storing the bitmap data in a hard disk or other long-term memory device is unnecessary and even inefficient.

In order to determine uniqueness, the system uses a bloom filter where a high level of hash-indexes are used to represent every single machine identifier appearing across of a group of locations. The bloom filter can guarantee that a lookup of a machine identifier that does not give a hit means that the machine identifier was not seen in these locations. However, if there is a hit there is only a statistical guarantee that the given device having that machine identifier has been seen. That guarantee can be tuned up or down to provide more or less privacy (collisions) while providing less accuracy in the counts. Given that the filter has a known error margin it can be accounted and compensated for post factum. This approach allows the system to track unique visitors, and recurring visitors and total visits. Furthermore, someone who gets access to the stored bloom filter will not be able to revert the bits to machine identifiers (hashed/salted) since a one-way hash functions is used to turn on bits and a single bit may represent many machine identifiers.

To compute dwell-time and conversion rates and total visits the system does not need to store the machine identifiers with the visit record. The system can sum up statistics progressively from raw visit records. After the raw visits have been summarized (which can be done at any arbitrary frequency), they may be removed from disk. To further obfuscate the data, the system can write random machine identifiers with a set level of collisions into the visit records without affecting the results.

Where the bitmaps are stored on the application server 26, the detectors 46 transmit the hashed identifiers to the application server 26. In these embodiments, the detector software may be very lightweight. The detector 46 only is required to include the detector software, the hashing algorithm, and network communication software. The counting and analytics may be executed on either the detector 46 or the application server 26. Where the counting is executed on the detector 46, the detector's output is merely the count of devices.

Returning to FIG. 5, steps for embodiments of the method proceed where first: in step 502, a sensor receives a machine identifier from wireless network communications. This begins the creation of a visitor record. In some embodiments, the sensor may pose as a wireless access point to trigger or provoke the mobile device to transmit data including a machine identifier. In step 504, in some embodiments, the machine identifier is salted (e.g., additional characters are added to the machine identifier that that will dramatically change the output of a hash function. The salt value may be static for a given sensor, or it may vary. In embodiments where the salt value varies, the value may change periodically, or at unpredictable intervals. The salt value may also not be able to be recovered once changed, thus it makes it impossible to recreate a visit record.

In step 506, the machine identifier is hashed with a one-way hash function. In step 508 the hash value is compared to a uniqueness filter. A uniqueness filter is also commonly known as a Bloom Filter. There are many implementations of a bloom filter, though one that receives notable focus in this application is the use of a bitmap. Another implementation merely uses a contextual hash function to generate a sub-hash to check for uniqueness. In some embodiments, step 504 and 506 are skipped. In these embodiments, the machine identifier is still not saved or stored anywhere in the uniqueness filter. Implementations of the uniqueness filter may themselves involve a hash function (or multiple hash functions) with or without a salt value. One implementation that does include steps 504 and 506 involves scaling the hash value to a bitmap and then examining whether a corresponding bit (or bits) in the bitmap is/are full or not. The scaling function may be yet another hash function that has a high probability of collision than the hash function of step 506.

In step 510, the uniqueness filter is evaluated for whether the visitor is recurring or not. If the visitor is new, in step 512 the system counts the visitor as a new unique visitor. One embodiment of this is where the corresponding bit in the bitmap is empty (e.g., value 0 or white). If the visitor is recurring, in step 514 the system counts the visitor as a recurring visitor. One embodiment of this is where the corresponding bit in the bitmap is full (e.g., value 1 or black).

In some embodiments, step 510 is performed in batches. And So even if an interested party were to trace the queries to the database, they would not be able to tell which machine identifiers are storing, as the different bits turned on or checked may overlap. For example, if three machine identifiers corresponded to bits “3,5,8,” “3,4,7,” and “7,8,9” respectively are detected, the bits checked and filled are 3,4,5,7,8,9. From this set, a change log for the bitmap does not reveal the corresponding bits that each individual machine identifier corresponded to. The information regarding each of the three sets is only kept temporarily in memory rather than written to disk.

Where the three machine identifiers A, B, and C are received, the first step is to compute in memory the union of all bits that A, B, and C occupy. Then, query those bits from the database. Next, in the memory, the system checks the individual bits corresponding to the machine identifiers (“3,5,8,” “3,4,7,” and “7,8,9”) against the full bits in the database.

Another implementation of performing step 510 uses a sub-hash. That function may be described as:

Sub-Hash=hash_function(subhash_length,composition_function(cryptographic key,sub-hash_method,sub-hash_parameters,Original hash))

The sub-hash length value controls the length (in characters) of the output, the composition function produces output based on a number of inputs including a key, method and parameters of hashing, and the original hash of the machine identifier (from step 506). The conversion space occupied by the sub-hash is often smaller than that of the original hash, and thus there are more collisions. However, this creates a known error rate that can be applied to total counts of visitors or recurring visitors.

The sub-hash methods may include examples such as:

Randomizer:

Generates a sub-hash of length subhash_length that is random—the same original_hash is remapped differently after each computation call The sub_hash of a phone always changes.

Preserver:

Generates a sub-hash that is equal to the original hash—the same original hash is remapped the same way after each computation call. One may choose this options at places/in countries where privacy rules need not to apply or in the case analytics computations are more precise.

Silencer:

Generates a sub-hash of length subhash length that is a constant. All original hashes are mapped to the same unique value. All devices have the same sub-hash.

Quantizer:

Generates a sub-hash of length subhash length using the original hash—the same original hash is remapped the same way after each computation call.

Adaptive_Salt_Quantizer:

Generates a sub-hash of length subhash length using the cryptographic key, the original hash and a contextual salt.

The contextual salt can be:
#1) an ID of to which the sensor is attached (e.g. location, or a sensor number)—a same original hash will have different subhash values based on the sensor it is detected by. E.g. tracking is impossible across geographic locations. (The same phone will not appear as the same phone at different locations because the salt is different).
#2) the ID of the timeslot corresponding to the real-time timestamp—a same original hash will have different sub-hash values based on when it is observed. Fuzzy tracking is impossible when too much time passes by but possible over a limited time span. The time granularity can vary such as by the hour or the day.
#3) a secret key that depends on the system deployment instance (e.g. Europe region versus Asia region).
#4) a constant (salt value is always the same regardless of where/when the phone is detected).
The contextual salt strategy may also combine multiple contextual values. E.g. location_id OR location id+secret.

In step 516, the system evaluates the total number of visitors in a given period based on the cardinality of the visitor records. The visitor records are written without reference to the machine identifier or with a randomized identifier. In some embodiments, step 516 is performed periodically, and includes summary statistics on visits, dwell time, bin distribution, distance distribution, and total visits, whether the visit was from a random MAC (e.g., some machine identifiers aren't real identifiers to begin with) or not. These numbers are timestamped and can then be aggregated in user selected ranges and time slots, without knowing the actual machine identifiers or identity of a visitor.

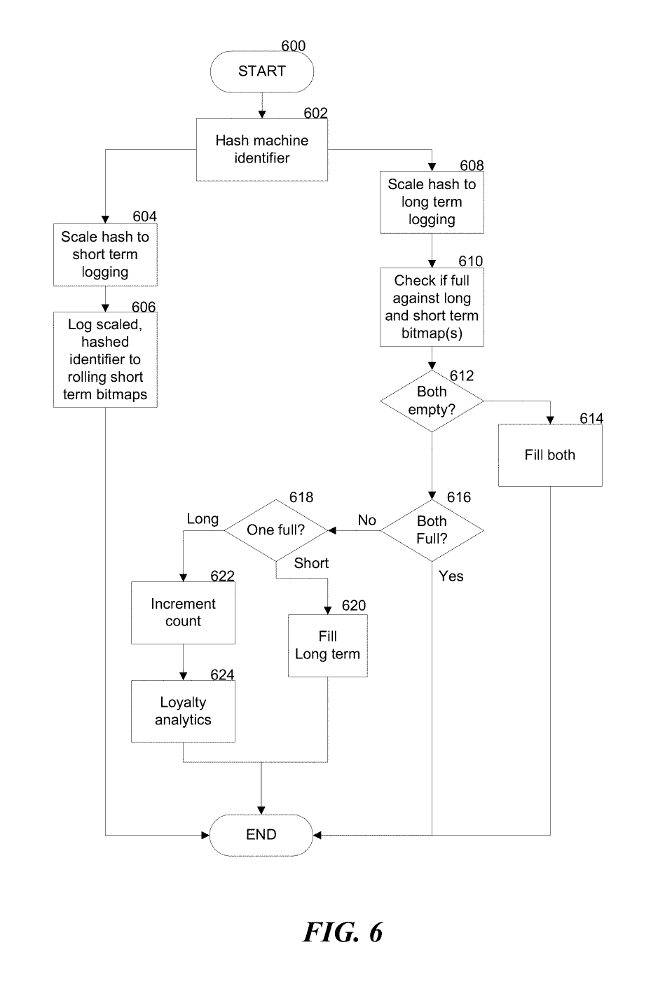

FIG. 6 is a flowchart illustrating a method of maintaining multiple bitmap tracking systems over varied lifespans. Thus far, bitmaps have been disclosed as each having the same lifespan. In some embodiments, bitmaps may have differing lifespans. Having varied lifespans adds additional functionality.

In step 602, the machine identifier of a device is hashed. The same hash function is used regardless of bitmap size or lifespan. In step 604, the hash is scaled to a short-term log (set of rolling bitmaps). In step 606, a first set of rolling bitmaps operates as described in FIG. 4. The count is maintained over a lifespan of, for example, 10 minutes.

In step 608, a second, the scaling function scales the hash to a longer-term log (bitmap or set of bitmaps). The longer-term bitmap(s) may have a lifespan of, for example, a month. Over the course of a given month, it is possible that the short-term bitmap would fill up entirely, or the margin of error would be exceeded. In some embodiments, the size of the bitmap scales to both the number of expected visitors, and the lifespan of the bitmap. Thus, the scaling function is different for the longer-term bitmap(s). However, in order to compare two bitmaps, they must be the same size, and thus use the same scaling function. Thus, in an embodiment where the short term and long term bitmaps are compared, the scaling function of step 604 and 608 are the same.

In step 610, the scaled and hashed machine identifier is checked against both the long-term and short-term bitmaps. In step 612, the detection system determines whether the bit corresponding to that device is empty in both sets of bitmaps. If not, in step 616, the detection system determines whether the bit corresponding to that device is full in both sets of bitmaps. Where the bit is full in both sets of bitmaps, no further action is taken. If both are not full, in step 618, the detection system determines which of the two bitmap sets is full. If the bit is full in only the short-term bitmap, in step 620 the corresponding bit is filled in the long-term bitmap set.

If the bit is full in only the long-term bitmap, in step 622, a visit counter is incremented. The visit counter is another data structure separate from, but corresponding to the bitmap. On a longer-term bitmap it is possible that a given visitor arrives, leaves, and then returns. In this manner, maintained presence in the location does not increment the counter at each detection (depending on detection rate of the detector, possibly multiple times a second).

Rather, the counter is incremented when the short lifespan bitmap does not have record of the particular device. Thus, the device has at least been absent from the location for the short lifespan.

In step 624, analytics may be run on the visit counters. The detection system is enabled to determine the average number of times a given user visits during the long term bitmap's lifespan. This lets a given location determine whether the traffic experienced is largely repeat or new visitors.

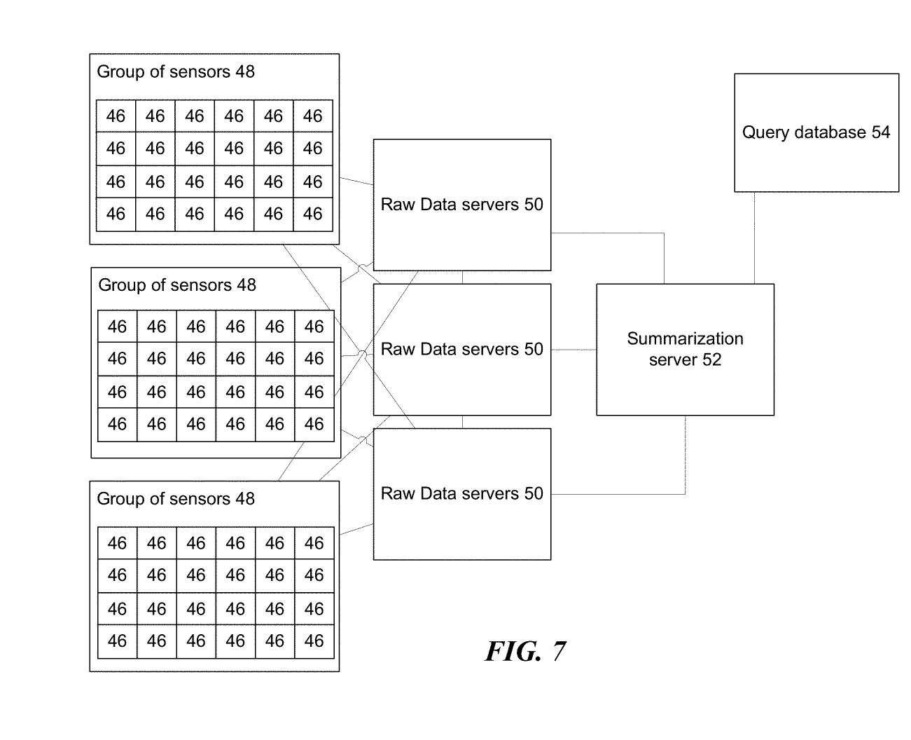

FIG. 7 is a block diagram illustrating a scaled network architecture. At the bottom level, there are a number of individual people-counting sensors 46 sending raw data independently at intervals tagged with sensor IDs. The figure illustrates the sensors 46 as organized into groups of sensors 48. The groups of sensors 48 are determined based on the chosen deployment. For purposes of the figure, the particular grouping of sensors 46 is arbitrary. Considerations involved in the groupings for particular deployments include the sorts of structures people traffic is being monitored in, the geographic range and scope people are being monitored, and the ownership scheme of the sensors 46.

The raw data servers act as a store and forward persistent messaging bus that receives the raw data and batched (groups) based on sensor ID (e.g., point of origin). As data comes into the system at a high rate from many different, potentially geographically distributed locations it is important to aggregate and submit large batches to make the best of available bandwidth. The raw data servers 50 utilize a store and forward messaging system as a first line of defense against high volumes.

The raw data servers 50 make use of a distributed time-series database and are a distributed memory buffering mechanism that collects a stream of visits from a single sensor 46. A single sensor 46 writes sequentially to a single database location. Hence, the raw data servers 50 convert a random access write pattern into a much more efficient sequential write.

To simplify cross-origin aggregation (aggregation by groups of sensors 48) the raw data sensors write each origin in a group of sensors 48 to a “nearby” location. For example, the raw data servers write visits from a given sensor 46 into the same row of a relational database and the visits from the same group of sensors 48 into the same table. In other words the primary key is origin and the secondary key (index) is the group. The raw data servers 50 store the raw data in a time series format, not a relational format. Hence, the raw data is easy to aggregate and range query by time (the high-level primary key is a timestamp). The raw data servers 50 purge records periodically. The purge may be based on a record lifespan, or a database clear. For example, records that are 24 hours old may be deleted, or an entire table may be cleared once every 24 hours.

The summarization servers 52 keep track of ongoing visits, and when the visits end (e.g., a given smart phone goes undetected for ˜10 min). When a visit ends, that visit is written to a column store database on the summarization server 52. Visits are ingested into a persistent index structure optimized for summarization (based on sensor ID), in a time series database. In some embodiments, the ingest and the visit ends may be written to separate databases.

Periodically (e.g., every hour) the summarizations servers 52 batch and summarize the data. The summarization process reduces the available data fields of the raw data. For example, in some embodiments, the batching process reduces the raw data to merely a record of a given visit at a given sensor 46 with a timestamp. This significantly reduces the size of the data making the batched package of data significantly more scalable. The summaries may be enhanced to include data regarding the group of sensors 48, where each sensor 46 can be associated with a number of logical groups, and states can be computed with regards to each group of sensors 48. This additional data has a marginal effect on package size. One method to keep the data size down uses an origin identification scheme whereby a single ID designation denotes both an ID for an individual sensor 52, and the group of sensors 54 to which that sensor 52 belongs.

Periodically, at a rate independent from the batching process (e.g., daily), the query database 48 receives the summarized data packages form the summarization server 46 and writes the package into a relational structure database for reports and queries. Finally, the reports are computed live based on the summarized relational data and modified by mathematical approximations discussed further below.

At each layer of servers 50, 52, 54 progressively reduces the number of servers. The architecture transitions from many servers performing many writes and infrequent reads, to a small group of servers that perform infrequent writes (perhaps once daily) and many reads (prepared each time a user requests a report). In this manner, conflicting writes and reads are reduced and the network scales. At each level, a database structure is used that lends to the sort of raw data that is generated by people-counter sensors 46. The first layer uses a distributed time-series database and the top-level backend servers make use of a relational database.

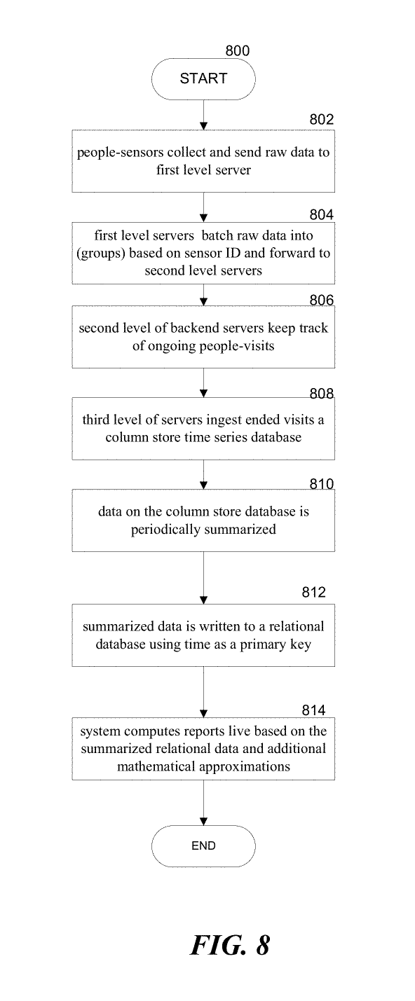

FIG. 8 is a flowchart depicting ingestion and processing of raw data. In step 802, a plurality of people-sensors collect and send raw data independently at fixed intervals tagged with a respective sensor id to a first level of backend servers. In step 804, the first level of backend servers configured as store and forward persistent messaging buses receives the data and batched (groups) based on sensor ID. The data stored and forwarded by the first level of backend servers is made available to a second level of backend servers. In step 806, the second level of backend servers keep track of ongoing people-visits (as determined by the raw data).

In step 808, when visits end (e.g., no detection of device for ˜10 min) the ended visit is written to the next level of backend server. The third level of backend servers ingest the ended visits into a persistent index structure optimized for summarization (based on sensor ID), in a time series database. The time-series database is a column store type database. In step 810, the data on the column store database is periodically (e.g., every hour) summarized. Summarization includes counting the number of completed visits since the last summarization.

In step 812, periodically, though at an independent interval (e.g., daily), the summarized data is written to a relational database using time as a primary key. In step 814, the system computes reports live based on the summarized relational data and additional mathematical approximations.

Relational data bases are good for reporting and can work on summarized data efficiently. However, they are not equipped to handle large volumes of raw data being ingested. Distributed column store databases, like Cassandra, are very resource hungry in small deployments, and do not aggregate time series data as efficiently. Using both styles of database (relational and column store) for respective tasks within the disclosed solution improves the overall scalability of the network and enables computationally inexpensive methods to ingest and report people-counting data.

The summarized data is the base data used to compute statistics, especially statistics over extended periods of time (greater than a day). In some embodiments, the window of processing the raw data is a calendar day. This is a result that the raw data requires significant disk space, and is computationally expensive to query. For some expensive computations the system progressively timestamps a last processed visit to avoid recomputing the statistics across the same visits. Data is ingested in sorted order by location and visit end time to allow progressive processing. Ingesting in this fashion improves ease of aggregation for stats, such as the distribution of dwell times, where bucket counts can be added across arbitrary time ranges. In some embodiments, all the raw data is summarized into hourly and daily counts. For hourly summarization the network may merely provide the raw visitor counts.

Queries are made on the summarized data. This is comparatively less computationally expensive than querying the raw data, and further enables purging of the raw data periodically (as does not required continued use). Daily stats are in summarized and provided through an API that can be used in a reporting system to users. Furthermore, the network may cache the most recent dump of summary stats for clients that just want the most recent summary stats (as opposed to a report).

The queries are run on the recent summary dump or the hourly, daily summaries in the database for quick retrieval. In some embodiments, queries are limited to those with a time scale spanning a day or part of day of data. Other queries access a dump cache. This is because the data is shared daily. Queries on summarized data limited to a single day are computationally cheap. The queries aggregate over time and sum up aggregate stats from shorter time ranges. In some embodiments, the queries are run on both given sensors (point of origin) and/or groups of sensors (region of origin).

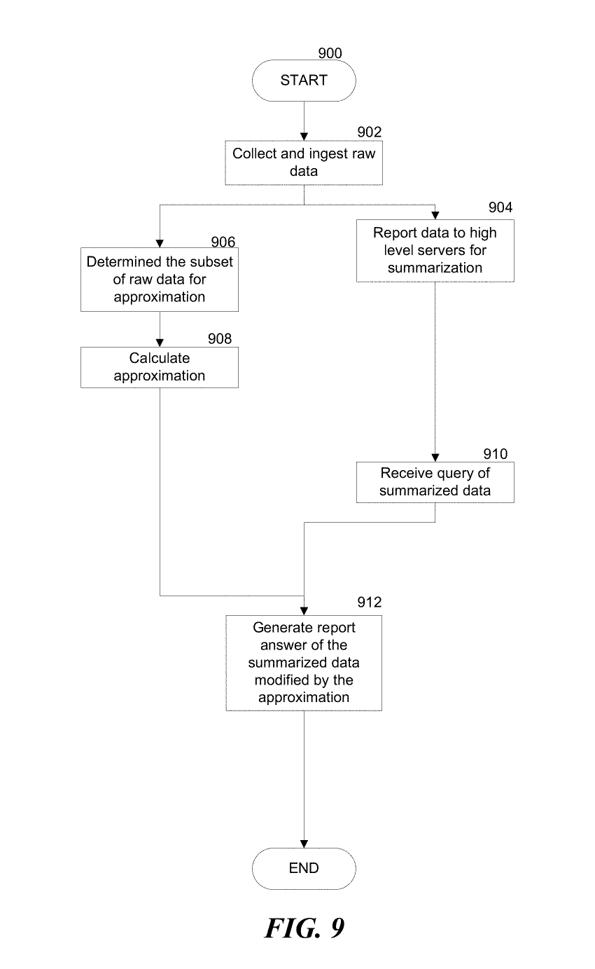

FIG. 9 is a flowchart depicting report generation involving summarized data modified by approximated statistics. Some statistics are difficult to scale. They either cannot be derived from summarized data or are very computationally expensive to run periodically. Thus, to generate this type of statistic, the system will approximate the statistic from the raw data, and then apply the approximation to the reports queried from the summarized data. The manner in which the approximation is used to modify the queried summarized data varies depending on the nature of the query on the summarized data.

In particular, these statistics are those that rely on movements of sensed visits and individual tracking of visit or device IDs. Thus, for two types of statistics: visit recurrence distribution and foot traffic vs car traffic ratios, the system uses approximations. The approximations are measurements and statistics to infer the derived metrics based on models of trained data. In some embodiments, training is performed periodically or for different major deployment types (depending on how the system is implemented and what use the system is being put to). The training uses the raw data, but only a subset of that raw data. Thus, the generation of an approximation is not as computationally expensive as generating a true statistic. Retraining periodically is not necessary if conditions don't change.

In step 902, raw data is ingested. In step 904 the raw data is reported to high level servers and databases and summarized. In step 906, a subset of the raw data is determined based on the deployment style. In some embodiments an arbitrary subset of data is selected. In some deployments a representative subset of data is selected. To determine the subset of the raw data first a time range should be determined. The time range does not need to be linear (e.g., 15 minutes from three different points in a given day may be used).

A time range is to be representative of the population trends that reports are desired for. For example, if the deployment regards marketing in a chain of grocery stores, choosing a time when the stores are generally closed would not be representative. Further only examining a narrow portion of the day would not account for rush hours (e.g., visits after the majority of a population gets off work). Each deployment is unique, and a representative time is determined based on the unique factors that contribute to people-traffic in that deployment.

Similarly, the subset of raw data accounts for points of origin polled. The origin points used in the approximation are also representative. In some deployments, a single sensor is used to represent the raw data, in others multiple sensors or multiple groups of sensors are used. If the deployment is focused on traffic through a stadium, multiple sensors at one or more of the entrances are selected. These sensors may all be grouped together. In another deployment for a chain restaurant, a single sensor from a number of restaurants across multiple states may be selected. Once again, each deployment is unique, and a representative arrangement of sensors is determined based on the unique factors that contribute to people-traffic and geography in that deployment.

In step 908, the approximation is calculated from the subset of the raw data. The approximation returns a percentage of the total that fits a certain visitor class. In step 910, that percentage is applied to the summarized data based on a report query to generate a report.

In step 910, the system receives a query of the summarized data. The query may specify a number of visitors of a particular class over a time period. In step 912 the system generates a report that includes the total visitor population from the summarized data as modified by the approximation to determine the number of visitors in the queried visitor class.

For example, a given report queries the number of pedestrians who have passed through a given point of origin (sensor detection radius) over a particular time period. To execute the query, the summarized data is queried for the total visits over the specified time period (e.g., 10,000). Then, the approximation of the percentage of pedestrians to automobiles (e.g., 60% pedestrians) is applied to that total number. The return to the query is then the total visitors modified by the approximation (e.g., 6,000). The query of the relational database is computationally inexpensive because the data is relatively simple, and sorted only by primary key, whereas the modification by the approximation is a single computation.

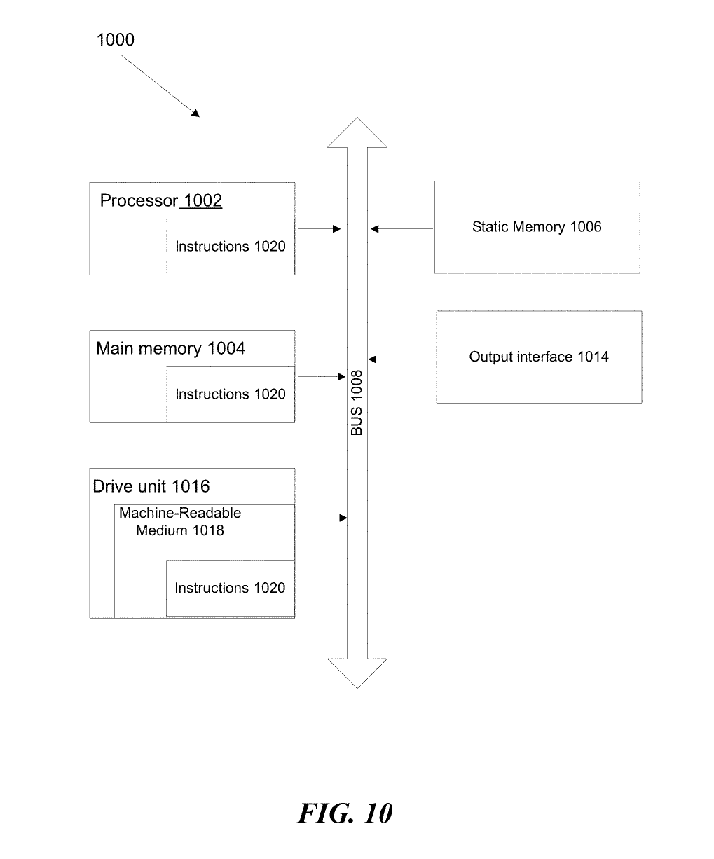

FIG. 10 is a block schematic diagram of a system in the exemplary form of a computer system 1000 within which a set of instructions for causing the system to perform any one of the foregoing methodologies and logical flows may be executed.

The computer system 1000 includes a processor 1002, a main memory 1004, and a static memory 1006, which communicate with each other via a bus 1008. The computer system 700 also includes an output interface 1014; for example, a USB interface, a network interface, or electrical signal connections and/or contacts;

The disk drive unit 1016 includes a machine-readable medium 1018 upon which is stored a set of executable instructions, i.e., software 1020, embodying any one, or all, of the methodologies described herein. The software 1020 is also shown to reside, completely or at least partially, within the main memory 1004 and/or within the processor 1002. The software 1020 may further be transmitted or received over a network by means of a network interface device 1014.

In contrast to the system 1000 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g., a computer. For example, a machine-readable medium includes read-only memory (ROM); random access memory (RAM); magnetic disk storage media; optical storage media; flash memory devices; electrical, optical, acoustical or other form of propagated signals such as carrier waves, infrared signals, digital signals, etc.; or any other type of media suitable for storing or transmitting information.

Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations (e.g., requiring cables and complex software configurations, or requiring a consultant to install). For example, embodiments may provide one or more cloud computing solutions that enable users, e.g., users on the go, to access real-time video delivery on such internet-enabled or other network-enabled devices, servers, or clients in accordance with embodiments herein. It further should be appreciated that one or more cloud computing embodiments include real-time video delivery using mobile devices, tablets, and the like, as such devices are becoming standard consumer devices.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

1. A method for protecting personally identifying information of mobile devices from a people-counting sensor system that counts people via wireless signals emitted from their respective mobile devices comprising:
collecting, by a people-counting sensor, data identifying a mobile device of a user based on physical proximity to the people-counting sensor, wherein said collecting is performed without input by the user of the mobile device and the data identifying the mobile device is not stored on the people-counting sensor;
hashing the data identifying the mobile device to generate hashed data; and
evaluating the hashed data for uniqueness within the people-counting sensor system.

2. The method of claim 1, further comprising:
evaluating the hashed data for cardinality within the people-counting sensor system.

3. The method of claim 1, wherein the data identifying the mobile device is a MAC address.

4. The method of claim 1, further comprising:
salting the data identifying the mobile device prior to said hashing using a salt value.

5. The method of claim 4, further comprising:
assigning the salt value contextually based on any of:
a location or identifier of the people-counting sensor;
a time period wherein said collecting occurs;
a constant; or
a cryptographic key.

6. The method of claim 1, wherein said evaluating is performed by:
corresponding the hashed data to a bit in a bitmap; and
determining whether the bit is full, wherein a full bit corresponds to a recurring mobile device.

7. The method of claim 6, further comprising:
clearing the bitmap on a periodic basis.

8. The method of claim 7, wherein the bitmap is a first bitmap and the method further including a second bitmap having the same size as the first bitmap, and wherein the first and second bitmaps are used on a rolling basis to determine whether the bit corresponding to the hashed data is full.

9. The method of claim 6, further comprising;
evaluating the bitmap for cardinality to determine the number of people present within a range for the people-counting sensor at a given time.

10. The method of claim 1, wherein the people-counting sensor system includes any of:
a memory of a single sensor;
a memory of a group of sensors; or
a database server in communication with the people-counting sensor.

11. The method of claim 1, wherein the hash function has multiple inputs wherein each input beyond the data identifying the mobile device affects the ability to track recurrence of the mobile device by the people-counting sensor system.

12. The method of claim 1, wherein the hash function is multi-staged.

13. A method for protecting personally identifying information of mobile devices comprising:
collecting, by a people-counting sensor, a machine identifier of a mobile device of a user based on physical proximity to the people-counting sensor and wireless network transmissions emitted by the mobile device, wherein said collecting is performed without input by the user of the mobile device and the data identifying the mobile device is not stored on the people-counting sensor;
hashing the machine identifier to generate a hash value;
evaluating the hash value for uniqueness within a database;
recording, in a database, a visit to the people-counting sensor of the hash value; and
evaluating a number of visits to the people-counting sensor based on the database.

14. The method of claim 13, further comprising:
salting the machine identifier prior to said hashing using a salt value.

15. The method of claim 14, further comprising:
assigning the salt value contextually based on any of:
a location or identifier of the people-counting sensor;
a time period wherein said collecting occurs;
a constant; or
a cryptographic key.

16. The method of claim 13, further comprising:
corresponding the hashed value to a bit in a bitmap; and
determining whether the bit is full, wherein:
if the bit is empty, then the bit is filled, and the mobile device is evaluated as a unique, new visitor; or
if the bit is full, then the mobile device is evaluated as a previously seen mobile device.

17. The method of claim 16, wherein data associated with the machine identifier is not stored in any data structure other than the bitmap.

18. The method of claim 16, further comprising:
clearing the bitmap on a periodic basis.

19. The method of claim 13, further comprising:
corresponding the hashed value to a bit in a first bitmap and a second bitmap having the same size;
copying and clearing bits between the first and second bitmaps in a rolling fashion; and
determining whether the bit on an active bitmap is full, wherein:
if the bit is empty, then the bit is filled, and the mobile device is evaluated as a unique, new visitor; or
if the bit is full, then the mobile device is evaluated as a previously seen mobile device.

20. A system for protecting personally identifying information of mobile devices comprising:
a people-counting sensor configured to obtain data identifying a mobile device based on physical proximity to the people-counting sensor and wireless network transmissions emitted by the mobile device and hash the data identifying the mobile device into hashed data, wherein obtaining is performed without input by a user of the mobile device and the data identifying the mobile device is not stored on the people-counting sensor; and
a server configured to store the hashed data in a database and evaluate queries for uniqueness of the hashed data and cardinality of database entries.

21. The system of claim 20, wherein the people-counting sensor is configured to salt the data identifying the mobile device prior to hashing using a salt value.

22. The system of claim 21, wherein the salt value is reassigned after a first time period.

23. The system of claim 20, wherein the people-counting sensor is further configured to:
correspond the hashed value to a bit in a bitmap; and
determine whether the bit is full, wherein:
if the bit is empty, then the bit is filled, and the mobile device is evaluated as a unique, new visitor; or
if the bit is full, then the mobile device is evaluated as a previously seen mobile device.

24. The system of claim 23, wherein the bitmap is cleared on a periodic basis.

25. A method for protecting personally identifying information of mobile devices from a people-counting sensor system that counts people via wireless signals emitted from their respective mobile devices comprising;
passively receiving, by a sensor, a machine identifier for a mobile device based on physical proximity to the sensor and wireless network transmissions emitted by the mobile device, wherein the data identifying the mobile device is not stored on the sensor;
generating a visit record based said receiving; and
writing the visit record without reference to the machine identifier or with a randomized identifier.

26. The method of claim 25, wherein the randomized identifier has some probability of a collision with other randomized identifiers.

27. The method of claim 25, further comprising:
evaluating the machine identifier through a uniqueness filter that does not store machine identifiers;
based on said evaluating, determining whether the visit record is a new unique visitor or a recurring visitor.

28. The method of claim 27, further comprising:
counting a total number of new unique visitors and recurring visitors.

29. The method of claim 28, wherein the uniqueness filter is a hash function scaled to a bitmap wherein one or more bits in the bitmap represents a given machine identifier.
